(19) United States
(12) Patent Application Publication
(10) Pub. No.: US 2021/0192012 A1
(43) Pub. Date: Jun. 24, 2021

(54) RIGHT HOLDER TERMINAL, USER TERMINAL, RIGHT HOLDER PROGRAM, USER PROGRAM, CONTENT UTILIZATION SYSTEM, AND CONTENT UTILIZATION METHOD

(71) Applicant: Nippon Telegraph and Telephone Corporation, Tokyo (JP)

(72) Inventors: Shigenori Ohashi, Musashino-shi, Tokyo (JP); Tatsuro ISHIDA, Musashino-shi, Tokyo (JP); Masayoshi CHIKADA, Musashino-shi, Tokyo (JP); Shigeru Fujimura, Musashino-shi, Tokyo (JP); Atsushi Nakadaira, Musashino-shi, Tokyo (JP); Hiroki Watanabe, Musashino-shi, Tokyo (JP)

(21) Appl. No.: 17/273,231

(22) PCT Filed: Sep. 6, 2019
(86) PCT No.: PCT/JP2019/035098

§ 371 Date: Mar. 3, 2021

(30) Foreign Application Priority Data
Sep. 7, 2018 (JP) 2018-167703

(51) Int. Cl. G06F 21/10; H04L 9/08; H04L 9/32

(52) U.S. Cl. CPC G06F 21/10; H04L 9/0894; H04L 2209/603; H04L 9/3236; H04L 2209/38; H04L 9/3247

(57) ABSTRACT

A right holder terminal 1 includes a registration unit that registers an identifier of a right holder in blockchain data registered with an identifier of a user, an electronic signature issuing unit that receives permission request data for content and transmits, to the user terminal, right holder electronic signature data generated by electronically signing a client random number issued by the user terminal by using a right holder secret key, a verification unit that receives user electronic signature data generated by electronically signing a server random number issued by the right holder terminal by using a user secret key and verifies that the user electronic signature data corresponds to the identifier of the user registered in the blockchain data, and a permission issuing unit that, if the user electronic signature data corresponds to the identifier of the user registered in the blockchain data, transmits the permission data.

### TECHNICAL FIELD

The present invention relates to a right holder terminal that is used by a right holder of content and transmits, to a user of the content, permission data for content, a user terminal that is used by the user of the content and transmits, to the right holder of the content, permission request data for content, a right holder program, a user program, a content use system, and a content use method.

### BACKGROUND ART

Examples of techniques to ensure by whom information is sent include an electronic signature. As a mechanism for realizing the electronic signature, an electronic signature based on public key cryptosystem has become popular.

In transactions of digital cryptocurrencies, a blockchain which is a type of a distributed ledger is used. In the blockchain, pieces of information on transactions of cryptocurrencies communicated among participants are collected in units of blocks to form the blockchain. With respect to a structure of the blockchain, as the term chain implies, each block is recorded in a manner that each block is linked to a previous block. Specifically, each block is linked by including a hash value of the previous block in the block.

If transaction information included in a block at a certain point in time is falsified, a hash value of the falsified block at a certain point in time is changed, and thus, it becomes necessary to falsify all blocks at and after the falsified block at a certain point in time. When a block is added, it is necessary to perform a very computationally intensive process (mining) of finding additional information (nonce) in which a hash value of a block matches a specific condition. If a falsification is made to a block, falsifications of all blocks at and after the falsified block become necessary and also, the addition of a block requires a very computationally intensive process. From the coupling of the above two factors, it can be said that the blockchain has a mechanism that is extremely robust against the falsification. In digital cryptocurrencies, the blockchain is one that is equivalent to a ledger for recording all transactions of cryptocurrencies, and requirements of transactions that ensure the reliability of cryptocurrencies are met by using the blockchain.

Focusing on the fact that the mechanism is extremely robust against falsifications of the blockchain, there is a method of using the blockchain for the permission management of digital content (see Patent document 1). In Patent document 1, a user and a right holder transmit and receive permission information of content such as a decryption key for using the content on the blockchain.

### PRIOR ART DOCUMENT

### Patent Document

Patent document 1: Japanese Patent Application Publication No. 2017-050763

### SUMMARY OF THE INVENTION

### Problem to be Solved by the Invention

However, in a method disclosed in Patent document 1, the permission of the use of content is managed on the blockchain. In the method disclosed in Patent document 1, the distribution of the content itself is not cooperated with the blockchain and is not managed on the blockchain. Therefore, there is a case where the transparency and reliability of the distribution of content is lacking.

It is also conceivable to adopt a method in which transactions of content itself are made on a distributed ledger such as a blockchain, but this is not an appropriate method because such a method would be lead to a bloated blockchain ledger.

Accordingly, an object of the present invention is to provide a right holder terminal, a user terminal, a right holder program, a user program, a content use system, and a content use method capable of delivering content while ensuring the transparency and reliability of a right holder and a user.

### Means for Solving the Problem

To solve the above described problem, a first feature of the present invention relates to a right holder terminal that is used by a right holder of content and transmits permission data for the content to a user of the content. The right holder terminal according to the first feature of the present invention includes a storage device that stores a right holder public key and a right holder secret key of the right holder, a registration unit that registers an identifier of the right holder in a distributed ledger registered with an identifier of the user, an electronic signature issuing unit that receives, from a user terminal used by the user, permission request data for the content and a client random number issued by the user terminal, and transmits, to the user terminal, right holder electronic signature data generated by electronically signing the client random number by using the right holder secret key, a verification unit that transmits, to the user terminal, a server random number issued by the right holder terminal, receives, from the user terminal, user electronic signature data generated by electronically signing the server random number by using a user secret key, and verifies that the user electronic signature data corresponds to the identifier of the user registered in the distributed ledger, and a permission issuing unit that, if the user electronic signature data corresponds to the identifier of the user registered in the distributed ledger, transmits the permission data to the user terminal.

The distributed ledger may be registered with a hash value of the right holder public key as the identifier of the right holder and may be registered with a hash value of a user public key corresponding to the user secret key as the identifier of the user, the right holder electronic signature data may be data generated by the right holder terminal electronically signing the client random number based on an electronic signature method in which the right holder public key can be restored by using the right holder secret key, the user electronic signature data may be data generated by the user terminal electronically signing the server random number based on an electronic signature method in which the user public key can be restored by using the user secret key, and the verification unit may restore the user public key from the user electronic signature data and may verify that the restored user public key corresponds to the hash value of the user public key registered in the distributed ledger.

The distributed ledger may be registered with the right holder public key as the identifier of the right holder and may be registered with a user public key as the identifier of the user, and the verification unit may obtain the user public key from the distributed ledger and may verify the user electronic signature data relative to the server random number by using the user public key.

The distributed ledger may be registered with a hash value of the right holder public key as the identifier of the right holder and may be registered with a hash value of a user public key as the identifier of the user, the right holder public key may be transmitted to the user terminal, and the verification unit may further obtain the user public key from the user terminal and verify that the obtained user public key corresponds to the hash value of the user public key registered in the distributed ledger.

The right holder terminal may further include an encryption unit that generates a right holder content public key and a right holder content secret key as a pair, transmits the right holder content public key to the user terminal, obtains, from the user terminal, a user content public key generated at the user terminal, generates a common key by using the right holder content secret key, and encrypts the content by using the common key.

A second feature of the present invention relates to a user terminal that is used by a user of content and transmits permission request data for the content to a right holder of the content. The user terminal according to the second feature of the present invention includes a storage device that stores a user public key and a user secret key of the user, a registration unit that registers an identifier of the user in a distributed ledger registered with an identifier of the right holder, a permission request unit that transmits the permission request data for the content to a right holder terminal used by the right holder, a verification unit that transmits a client random number issued by the user terminal to the right holder terminal, receives, from the right holder terminal, right holder electronic signature data generated by electronically signing the client random number by using a right holder secret key, and verifies that the right holder electronic signature data corresponds to the identifier of the right holder registered in the distributed ledger, an electronic signature issuing unit that receives, from the right holder terminal, a server random number issued by the right holder terminal and transmits, to the right holder terminal, user electronic signature data generated by electronically signing the server random number by using the user secret key, and a content use unit that starts using the content after receiving permission data from the right holder terminal.

The distributed ledger may be registered with a hash value of a right holder public key corresponding to the right holder secret key as the identifier of the right holder and may be registered with a hash value of the user public key as the identifier of the user, the right holder electronic signature data may be data generated by the right holder terminal electronically signing the client random number based on an electronic signature method in which the right holder public key can be restored by using the right holder secret key, the user electronic signature data may be data generated by the user terminal electronically signing the server random number based on an electronic signature method in which the user public key can be restored by using the user secret key, and the verification unit may restore the right holder public key from the right holder electronic signature data and may verify that the restored right holder public key corresponds to the hash value of the user public key registered in the distributed ledger.

The distributed ledger may be registered with a right holder public key as the identifier of the right holder and may be registered with the user public key as the identifier of the user and the verification unit may obtain the right holder public key from the distributed ledger and may verify the right holder electronic signature data relative to the client random number by using the right holder public key.

The distributed ledger may be registered with a hash value of a right holder public key as the identifier of the right holder and may be registered with a hash value of the user public key as the identifier of the user, the user public key may be transmitted to the right holder terminal, and the verification unit may further obtain the right holder public key from the right holder terminal and may verify that the obtained right holder public key corresponds to the hash value of the right holder public key registered in the distributed ledger.

The user terminal may further include a decryption unit that generates a user content public key and a user content secret key as a pair, transmits the user content public key to the right holder terminal, obtains, from the right holder terminal, a right holder content public key generated at the right holder terminal, generates a common key by using the right holder content public key and the user content secret key, and decrypts the content by using the common key.

A third feature of the present invention relates to a right holder program for causing a computer to function as the right holder terminal according to the first feature of the present invention.

A fourth feature of the present invention relates to a user program for causing a computer to function as the user terminal according to the second feature of the present invention.

A fifth feature of the present invention relates to a a content use system including a right holder terminal that is used by a right holder of content and transmits permission data for the content to a user of the content and a user terminal that is used by the user of the content and transmits permission request data for the content to the right holder of the content. In the content use system according to the fifth feature of the present invention, the right holder terminal incudes a storage device that stores a right holder public key and a right holder secret key of the right holder, a registration unit that registers the identifier of the right holder in a distributed ledger registered with an identifier of the user, an electronic signature issuing unit that receives, from the user terminal used by the user, the permission request data for the content and a client random number issued by the user terminal, and transmits, to the user terminal, right holder electronic signature data generated by electronically signing the client random number by using the right holder secret key, a verification unit that transmits a server random number issued by the right holder terminal to the user terminal, receives, from the user terminal, user electronic signature data generated by electronically signing the server random number by using a user secret key, and verifies that the user electronic signature data corresponds to the identifier of the user registered in the distributed ledger, and a permission issuing unit that, if the user electronic signature data corresponds to the identifier of the user registered in the distributed ledger, transmits the permission data to the user terminal; and the user terminal includes a storage device that stores a user public key and the user secret key of the user, a registration unit that registers the identifier of the user in a distributed ledger registered with the identifier of the right holder, a permission request unit that transmits the permission request data for the content to the right holder terminal used by the right holder, a verification unit that transmits the client random number issued by the user terminal to the right holder terminal, receives, from the right holder terminal, the right holder electronic signature data generated by electronically signing the client random number by using the right holder secret key, and verifies that the right holder electronic signature data corresponds to the identifier of the right holder registered in the distributed ledger, an electronic signature issuing unit that receives the server random number issued by the right holder terminal from the right holder terminal, and transmits, to the right holder terminal, the user electronic signature data generated by electronically signing the server random number by using the user secret key, and a content use unit that starts using the content after receiving the permission data from the right holder terminal.

A sixth feature of the present invention relates to a content use method for a content use system including a right holder terminal that is used by a right holder of content and transmits permission data for the content to a user of the content and a user terminal that is used by the user of the content and transmits permission request data for the content to the right holder of the content. The content use method according to the sixth feature of the present invention includes the steps of storing, by the right holder terminal, a right holder public key and a right holder secret key of the right holder in a storage device, storing, by the user terminal, a user public key and a user secret key of the user in a storage device, registering, by the right holder terminal, an identifier of the right holder in a distributed ledger registered with an identifier of the user, registering, by the user terminal, the identifier of the user in a distributed ledger registered with the identifier of the right holder, transmitting, by the user terminal, the permission request data for the content to the right holder terminal used by the right holder, transmitting, by the user terminal, a client random number issued by the user terminal to the right holder terminal, receiving, by the right holder terminal, from the user terminal used by the user, the permission request data for the content and the client random number issued by the user terminal, and transmitting, to the user terminal, right holder electronic signature data generated by electronically signing the client random number by using the right holder secret key, receiving, by the user terminal, from the right holder terminal, the right holder electronic signature data generated by electronically signing the client random number by using the right holder secret key, and verifying that the right holder electronic signature data corresponds to the identifier of the right holder registered in the distributed ledger, transmitting, by the right holder terminal, a server random number issued by the right holder terminal to the user terminal, receiving, by the user terminal, from the right holder terminal, the server random number issued by the right holder terminal and, transmitting, to the right holder terminal, user electronic signature data generated by electronically signing the server random number by using the user secret key, receiving, by the right holder terminal, from the user terminal, the user electronic signature data generated by electronically signing the server random number by using the user secret key, and verifying that the user electronic signature data corresponds to the identifier of the user registered in the distributed ledger, transmitting, by the right holder terminal, the permission data to the user terminal if the user electronic signature data corresponds to the identifier of the user registered in the distributed ledger, and using the content, by the user terminal, after the user terminal receiving the permission data from the right holder terminal.

### Effect of the Invention

According to the present invention, it is possible to provide a right holder terminal, a user terminal, a right holder program, a user program, a content use system and a content use method capable of delivering content while ensuring the transparency and reliability of a right holder and a user.

### BRIEF DESCRIPTION OF THE DRAWINGS

FIG. 1 is a system configuration diagram of a content use system according to the embodiments of the present invention.

FIG. 2 is a diagram for illustrating a hardware configuration and function blocks of a right holder terminal according to the embodiments of the present invention.

FIG. 3 is a diagram for illustrating a hardware configuration and function blocks of a user terminal according to the embodiments of the present invention.

FIG. 4 is a sequence diagram for illustrating a first application example of a content use method according to the embodiments of the present invention.

FIG. 5 is a sequence diagram for illustrating a second application example of a content use method according to the embodiments of the present invention.

FIG. 6 is a sequence diagram for illustrating a third application example of a content use method according to the embodiments of the present invention.

FIG. 7 is a diagram for illustrating a hardware configuration and function blocks of a right holder terminal according to a modified example.

FIG. 8 is a diagram for illustrating a hardware configuration and function blocks of a user terminal according to a modified example.

FIG. 9 is a sequence diagram for illustrating a content use method according to a modified example.

### MODE FOR CARRYING OUT THE INVENTION

Next, embodiments of the present invention will be described with reference to the drawings. In the descriptions of the drawings below, the same or similar parts are denoted with the same or similar reference numerals.

(Content Use System)

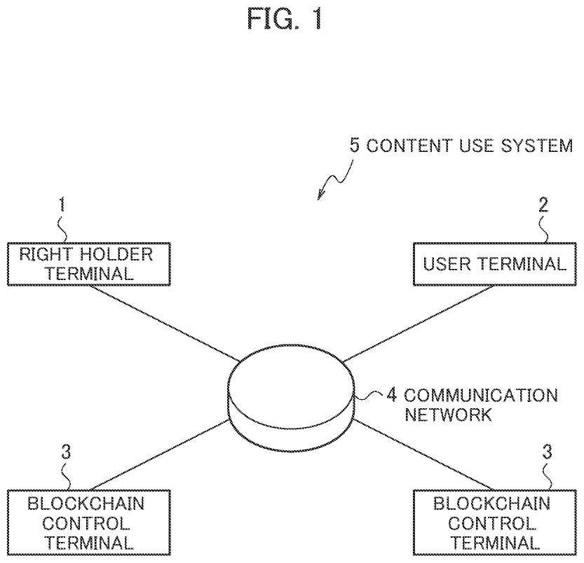

As illustrated in FIG. 1, a content use system 5 according to the embodiments of the present invention includes a right holder terminal 1, a user terminal 2, and blockchain control terminals 3. The right holder terminal 1, the user terminal 2 and the blockchain control terminals 3 are communicably connected one another via a communication network 4 such as the Internet. The number of terminals illustrated in FIG. 1 is just one example, and the number of terminals is not limited to the number described in the example.

The right holder terminal 1 is used by a content right holder and is configured to transmit permission data for content to a content user. The user terminal 2 is used by the content user and is configured to transmit permission request data for content to the content right holder. The blockchain control terminals 3 are used by persons other than the content right holder and the content user.

Each of the right holder terminal 1, the user terminal 2 and the blockchain control terminals 3 includes a blockchain, and a blockchain control unit for synchronizing with the blockchain. The right holder terminal 1, the user terminal 2 and the blockchain control terminals 3 gently synchronize with the blockchain to hold various pieces of transaction on the exchange and communication of cryptocurrencies and the like.

In the content use system 5 according to the embodiments of the present invention, pieces of information on the right holder and the user are transmitted and received in the blockchain when digital content is delivered, and thus, the right holder and the user can verify the validities each other. Further, by registering distribution, use, and viewing/listening histories and the like of the content in the blockchain, the respective histories of the content from a transaction history to distribution, use, and viewing/listening histories can be managed in the blockchain.

Further, generally, an electronic certificate is necessary for verifying an electronic signature. An electronic certificate is issued by a centralized organization called a certificate authority. Conventionally, the electronic certificate has been issued only to the right holder and thus, the user authenticates the right holder based on the electronic certificate of right holder to make a transaction with the right holder. Alternatively, the right holder (a servicer) who provides the content authenticates the user based on an identifier and a password input by the user.

On the other hand, in the content use system 5 according to the embodiments of the present invention, blockchain data B stores data based on which the right holder authenticates the user and data based on which the user authenticates the right holder. The transparency and the reliability of each authentication can be ensured because the blockchain data B is provided with the tamper resistance. Further, the user authenticates the right holder without using the electronic certificate, and thus, the certificate authority is not necessary, and alternatively, when the right holder authenticates the user, the user does not need to input the identifier and the password. In the content use system 5 according to the embodiments of the present invention, the right holder and the user authenticate each other based on the same method, and thus, the user and the right holder can make a transaction while having an equal relationship with each other, and such system is suitable for a system for transmitting and receiving content between two parties.

In the embodiments of the present invention, a case where pieces of information on the content right holder and the content user are transmitted and received via the blockchain is described, but the present invention is not limited to this. For example, the pieces of information on the content right holder and the content user may be transmitted and received by using another distributed ledgers instead of the blockchain.

(Right Holder Terminal)

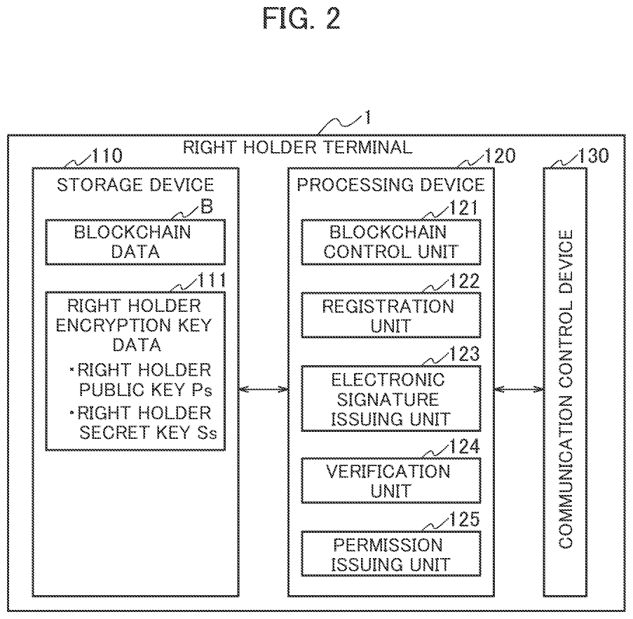

The right holder terminal 1 according to the embodiments of the present invention is described with reference to FIG. 2. The right holder terminal 1 is a general computer including a storage device 110, a processing device 120, and a communication control device 130. A general computer executes a right holder program to realize functions illustrated in FIG. 2.

The storage device 110 is an ROM (Read Only Memory), an RAM (Random access memory), a hard disk or the like, and stores various pieces of data such as input data, output data, and intermediate data required for the processing device 120 to perform processes. The processing device 120 is a CPU (Central Processing Unit) which reads and writes data stored in the storage device 110 and receives data from the communication control device 130 or outputs data to the communication control device 130 to perform processes in the right holder terminal 1. The communication control device 130 is an interface through which the right holder terminal 1 communicates with the user terminal 2.

The storage device 110 stores the right holder program, and also stores the blockchain data B and right holder encryption key data 111.

The blockchain data B is data of a blockchain that synchronizes with each terminal illustrated in FIG. 1. The blockchain data B is updated by a blockchain control unit 121.

The right holder encryption key data 111 is data of encryption keys used by the right holder. The right holder encryption key data 111 includes a right holder public key Ps and the right holder secret key Ss. The right holder public key Ps is data of a public key of the right holder, and alternatively, the right holder secret key Ss is data of a secret key of the right holder.

The processing device 120 includes a blockchain control unit 121, a registration unit 122, an electronic signature issuing unit 123, a verification unit 124, and a permission issuing unit 125.

The blockchain control unit 121 controls to gently synchronize the blockchain data B with blockchain data of another terminal the blockchain data B so that the blockchain data B becomes data in the latest state nearly in real time. The blockchain is formed by connecting a plurality of blocks in a chain shape. If a plurality of transactions are generated, the blockchain is updated after verifying whether it is possible to add, to a current blockchain, a block in which the plurality of transactions are collected.

The registration unit 122 registers an identifier of the right holder in the blockchain data B via a transaction generated by the blockchain control unit 121. An identifier of the user is also registered in the blockchain data B.

The electronic signature issuing unit 123 receives, from the user terminal 2, permission request data of content and a client random number Rb issued by the user terminal 2. The permission request data for content is set with information necessary for the user terminal 2 to use the content such as an identifier of the content. The electronic signature issuing unit 123 electronically signs the client random number Rc by using a right holder secret key Ss to generate right holder electronic signature data. The permission request data for content is set with pieces of information on an identifier of content that the user terminal 2 desires to use and the like. The electronic signature issuing unit 123 transmits the generated right holder electronic signature data to the user terminal 2.

The verification unit 124 transmits a server random number Rs issued by the right holder terminal 1 to the user terminal 2, and receives, from the user terminal 2, the user electronic signature data obtained by electronically signing a server random number Rs by using a user secret key Sc. The verification unit 124 verifies that the user electronic signature data received from the user terminal 2 corresponds to the identifier of the user registered in the blockchain data B.

If the user electronic signature data correspond to the identifier of the user registered in the blockchain data B, the permission issuing unit 125 transmits the permission data for permitting the use of the content to the user terminal 2. The permission data is set with information for the user terminal 2 to use the content such as content data. If the user electronic signature data does not correspond to the identifier of the user registered in the blockchain data B, the process is ended without permitting the use of the content.

(User Terminal)

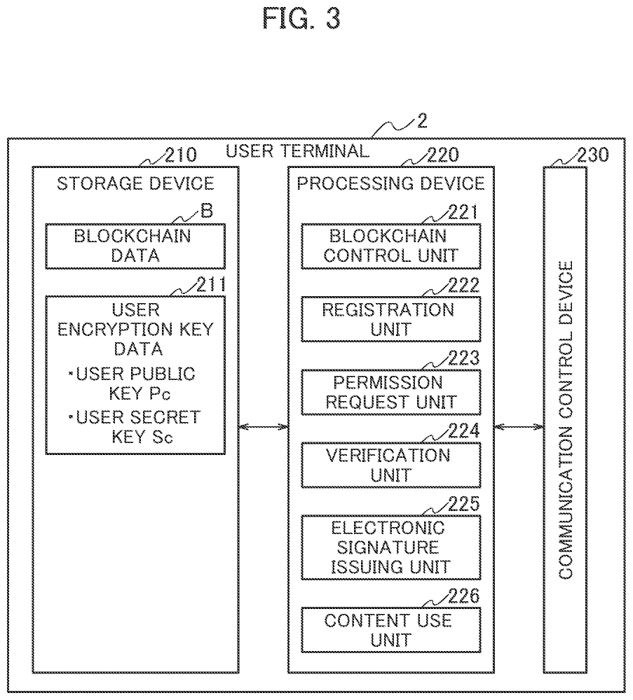

Referring to FIG. 3, the user terminal 2 according to the embodiments of the present invention will be described. The user terminal 2 is a general computer including a storage device 210, a processing device 220, and a communication control device 230. Functions illustrated in FIG. 3 are realized by the general computer executing the user program.

The storage device 210 and the processing device 220 are similar to the storage device 110 and the processing device 120 in the right holder terminal 1 described with reference to FIG. 2. Further, the communication control device 230 is an interface through which the user terminal 2 communicates with the right holder terminal 1.

The storage device 210 stores a user program, and also stores blockchain data B and user encryption key data 211.

The blockchain data B is similar to the blockchain data B described with reference to FIG. 2.

The user encryption key data 211 is data of encryption keys used by the user. The user encryption key data 211 includes a user public key Pc and a user secret key Sc. The user public key Pc is data of a public key of the user, and the user secret key Sc is data of a secret key of the user.

The processing device 220 includes a blockchain control unit 221, a registration unit 222, a permission request unit 223, a verification unit 224, an electronic signature issuing unit 225, and a content use unit 226.

The blockchain control unit 221 functions similarly to the blockchain control unit 121 described with reference to FIG. 2.

The registration unit 222 registers the identifier of the user in the blockchain data B via the blockchain control unit 221. The identifier of the right holder is also registered in the blockchain data B.

The permission request unit 223 transmits the permission request data for content to the right holder terminal 1.

The verification unit 224 transmits the client random number Rc issued by the user terminal 2 to the right holder terminal 1, and receives, from the right holder terminal 1, the right holder electronic signature data obtained by electronically signing the client random number Rc by using the right holder secret key Ss. The verification unit 224 verifies that the right holder electronic signature data corresponds to the identifier of the right holder registered in the blockchain data B. If the right holder electronic signature data corresponds to the identifier of the right holder registered in the blockchain data B, a process advances to a process of the electronic signature issuing unit 225.

The electronic signature issuing unit 225 receives the server random number Rs issued by the right holder terminal 1 from the right holder terminal 1, and generates the user electronic signature data obtained by electronically signing the server random number Rs by using the user secret key Sc. The electronic signature issuing unit 225 transmits the generated user electronic signature data to the right holder terminal 1.

The content use unit 226 uses the content after receiving permission data from the right holder terminal 1.

The processes of the right holder terminal 1 and the user terminal 2 illustrated in FIGS. 1 and 3 respectively will be described as first to third application examples.

### First Application Example

In the first application example, the blockchain data B is registered with a hash value of the right holder public key Ps corresponding to the right holder secret key Ss as the identifier of the right holder and is also registered with a hash value of the user public key Pc corresponding to the user secret key Sc as the identifier of the user. The hash value of the right holder public key Ps is a value obtained by inputting the right holder public key Ps to a hash function. Also, the hash value of the user public key Pc is a value obtained by inputting the user public key Pc to a hash function.

In the first application, as a method of an electronic signature, a method in which the electronic signature can be verified and the public key of an electronic signer can be restored is adopted. The method of the electronic signature used in the first application example is, for example, ECDSA (Elliptic Curve Digital Signature Algorithm) used in Ethereum or the like.

The right holder electronic signature data is data obtained by the right holder terminal 1 electronically signing the client random number Rc based on an electronic signature method in which the right holder public key can be restored by using the right holder secret key Ss. Further, the user electronic signature data is data obtained by the user terminal 2 electronically signing the server random number Rs based on an electronic signature method in which the user public key Pc can be restored by using the user secret key Sc.

The verification unit 124 in the right holder terminal 1 restores the user public key Pc from the user electronic signature data, and verifies that the restored user public key Pc corresponds to the hash value of the user public key Pc registered in the blockchain data B. The verification unit 124 in the right holder terminal 1 verifies whether a value obtained by inputting the user public key Pc restored from the user electronic signature data to a hash function is the hash value of the user public key Pc registered in the blockchain data B.

The verification unit 224 in the user terminal 2 restores the right holder public key Ps from the right holder electronic signature data, and verifies that the restored right holder public key Ps corresponds to the hash value of the user public key Pc registered in the blockchain data B. The verification unit 224 in the user terminal 2 verifies whether a value obtained by inputting the right holder public key Ps restored from the right holder electronic signature data to a hash function is the hash value of the right holder public key Ps registered in the blockchain data B.

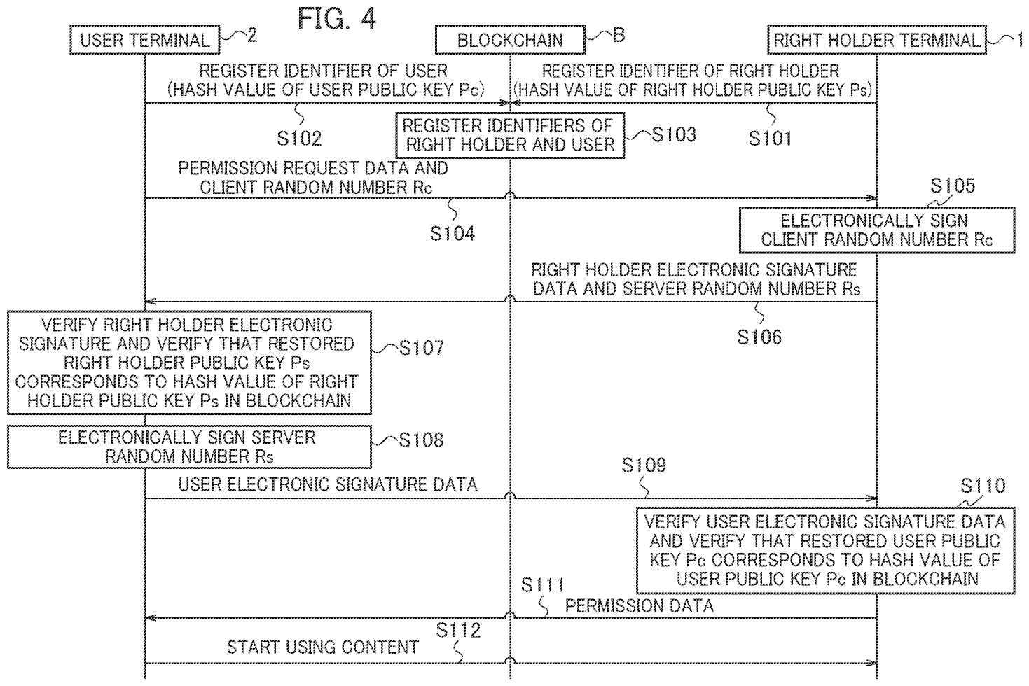

Referring to FIG. 4, processes in the first application example are described.

First, in step S101, the right holder terminal 1 requests the registration of the hash value of the right holder public key Ps in the blockchain data B as the identifier of the right holder. In step S102, the user terminal 2 requests the registration of the hash value of the user public key Pc in the blockchain data B as the identifier of the user. In step S103, the identifiers of the right holder and the user are registered in the blockchain data B and are synchronized in each terminal illustrated in FIG. 1.

In step S104, the user terminal 2 transmits the permission request data for content and a client random number Rc to the right holder terminal 1.

In step S105, the right holder terminal 1 electronically signs the received client random number Rc to generate right holder electronic signature data. The right holder terminal 1 makes an electronic signature based on a method in which the electronic signature can be verified and the public key of the electronic signer can be restored, such as ECDSA. In step S106, the right holder terminal 1 transmits the right holder electronic signature data and the server random number Rs to the user terminal 2.

In step S107, the user terminal 2 verifies the right holder electronic signature data. Specifically, the user terminal 2 verifies that the right holder public key Ps restored from the right holder electronic signature data corresponds to the hash value of the right holder public key Ps in the blockchain data B. In step S108, the user terminal 2 electronically signs the received server random number Rs to generate user electronic signature data. Here, the user terminal 2 makes an electronic signature based on a method in which the electronic signature can be verified and the public key of the electronic signer can be restored, such as ECDSA. In step S109, the user terminal 2 transmits the user electronic signature data to the right holder terminal 1.

In step S110, the right holder terminal 1 verifies the user electronic signature data. Specifically, the right holder terminal 1 verifies that the user public key Pc restored from the user electronic signature data corresponds to the hash value of the user public key Pc in the blockchain data B.

In step S110, if it can be confirmed that the user electronic signature data is generated by the user, in step S111, the right holder terminal 1 transmits the permission data to the user terminal 2. In step S112, the user terminal 2 starts using the content. In this case, histories of the distribution of the content by the right holder, histories of the use of the content by the user or histories of the viewing/listening of the content by the user may be registered in the blockchain data B.

In the first application example, the hash value of the right holder public key Ps and the hash value of the user public key Pc are registered in the blockchain data B, and thus, the identifiers of the right holder and the user can be registered as data having a constant length regardless of a length of the public key itself. This enables the reduction in data capacity of the blockchain data B. Further, the electrical signature is made based on the method in which the public key can be restored, and thus, the user and the right holder can verify validities each other.

### Second Application Example

In the second application example, the blockchain data B is registered with the right holder public key Ps as the identifier of the right holder and is registered with the user public key Pc as the identifier of the user.

The verification unit 124 in the right holder terminal 1 obtains the user public key Pc from the blockchain data B and verifies the user electronic signature data relative to the server random number Rs by using the obtained user public key Pc. The verification unit 124 in the right holder terminal 1 verifies, by using the user public key Pc obtained from the blockchain data B, whether the user electronic signature data is electrically signed by using the user secret key Sc, in other words, verifies whether the user electronic signature data is electrically signed by the user.

The verification unit 224 in the user terminal 2 obtains the right holder public key Ps from the blockchain data B and verifies the right holder electronic signature data relative to the client random number Rc by using the obtained right holder public key Ps. The verification unit 224 in the user terminal 2 verifies, by using the right holder public key Ps obtained from the blockchain data B, whether the right holder electronic signature data is electrically signed by using the right holder secret key Ss, in other words, verifies whether the right holder electronic signature data is electrically signed by the right holder.

Note that a general electronic signature method may be used in the second application example.

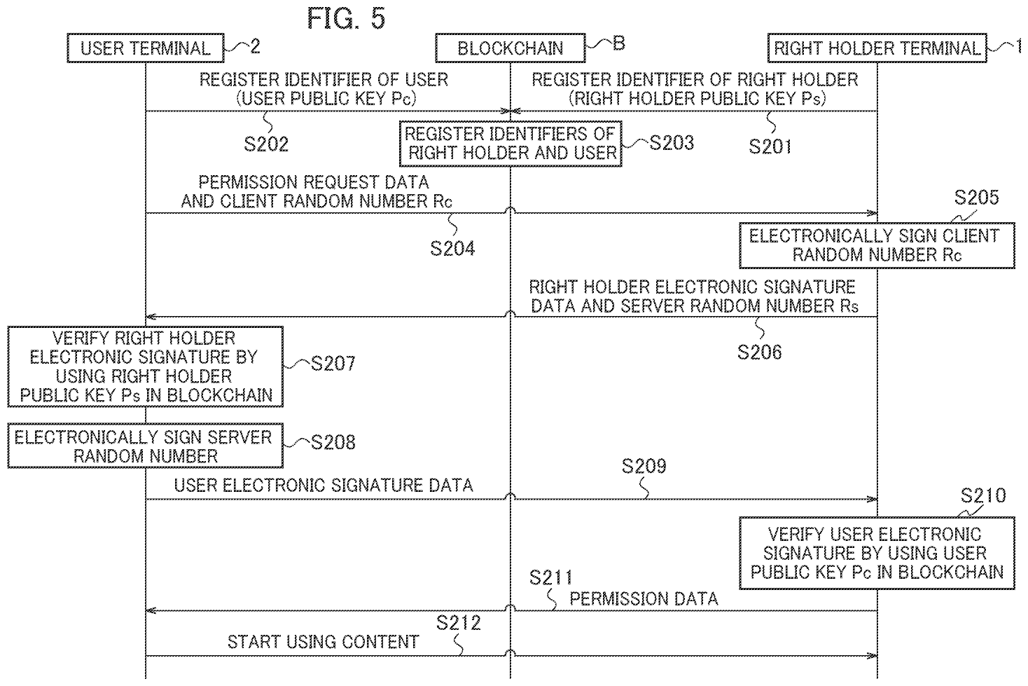

With Reference to FIG. 5, processes in the second application example will be described.

First, in step S201, the right holder terminal 1 requests the registration of the right holder public key Ps in the blockchain data B as the identifier of the right holder. In step S202, the user terminal 2 requests the registration of the user public key Pc in the blockchain data B as the identifier of the user. In step S203, the identifiers of the right holder and the user are registered in the blockchain data B and are synchronized in each terminal illustrated in FIG. 1.

In step S204, the user terminal 2 transmits the permission request data for content and the client random number Rc to the right holder terminal 1.

In step S205, the right holder terminal 1 electronically signs the received client random number Rc to generate right holder electronic signature data. In step S206, the right holder terminal 1 transmits the right holder electronic signature data and the server random number Rs to the user terminal 2.

In step S207, the user terminal 2 verifies the right holder electronic signature data. Specifically, the user terminal 2 verifies the right holder electronic signature data by using the right holder public key Ps registered in the blockchain data B. In step S208, the user terminal 2 electronically signs the received server random number Rs to generate user electronic signature data. In step S209, the user terminal 2 transmits the user electronic signature data to the right holder terminal 1.

In step S210, the right holder terminal 1 verifies the user electronic signature data. Specifically, the right holder terminal 1 verifies the user electronic signature data by using the user public key Pc registered in the blockchain data B.

In step S210, if it can be confirmed that the user electronic signature data is generated by the user, in step S211, the right holder terminal 1 transmits the permission data to the user terminal 2. In step S212, the user terminal 2 starts using the content. Histories of the distribution of the content by the right holder, histories of the use of the content by the user or histories of the viewing/listening of the content by the user may be registered in the blockchain data B.

In the second application example, the right holder public key Ps and the user public key Pc are registered in the blockchain data B, and the right holder and the user electronically sign a random number based on a conventional method. Therefore, the right holder and the user can confirm validities each other while ensuring the compatibility with the conventional method.

### Third Application Example

In the third application example, the blockchain data B is registered with the hash value of the right holder public key Ps as the identifier of the right holder and is registered with the hash value of the user public key Pc as the identifier of the user.

In the third application example, the right holder terminal 1 transmits the right holder public key Ps to the user terminal 2 and alternatively the user terminal 2 transmits the user public key Pc to the right holder terminal 1.

The verification unit 124 in the right holder terminal 1 obtains the user public key Pc from the user terminal 2 and verifies that the obtained user public key Pc corresponds to the hash value of the user public key Pc registered in the blockchain data B. Further, the verification unit 124 in the right holder terminal 1 verifies whether a value obtained by inputting, to a hash function, the user public key Pc obtained from the user terminal 2 is the hash value of the user public key Pc registered in the blockchain data B.

The verification unit 224 in the user terminal 2 obtains the right holder public key Ps from the right holder terminal 1 and verifies that the obtained right holder public key Ps corresponds to the hash value of the right holder public key Ps registered in the blockchain data B. The verification unit 224 in the user terminal 2 verifies whether a value obtained by inputting, to a hash function, the right holder public key Ps obtained from the right holder terminal 1 is the hash value of the right holder public key Ps registered in the blockchain data B.

A general electronic signature method may be used in the third application example.

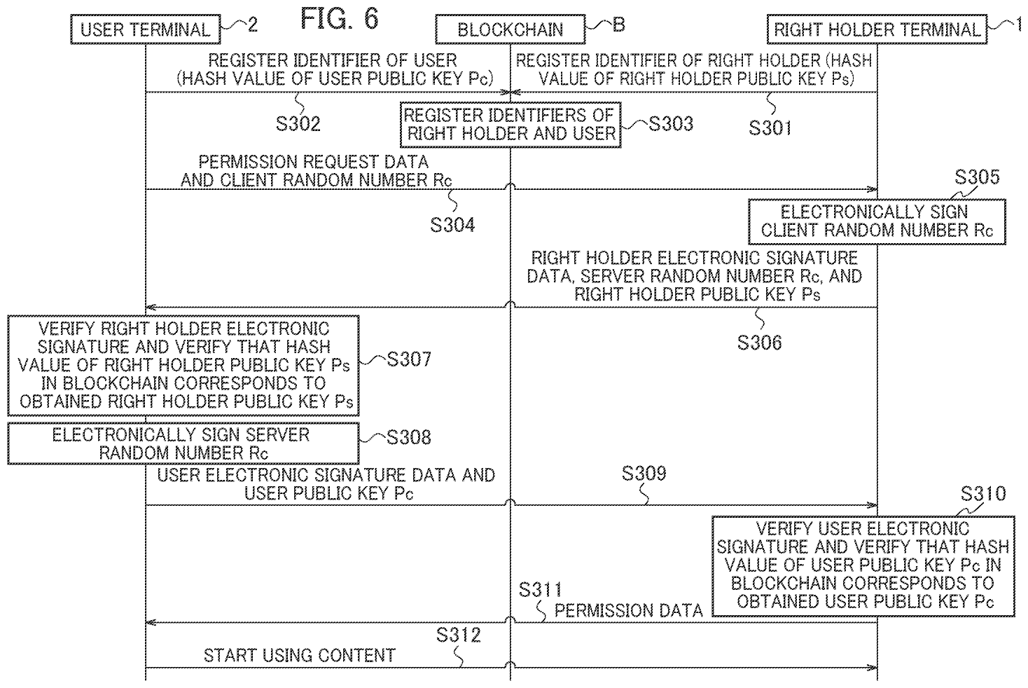

With reference to FIG. 6, processes in the third application example will be described.

First, in step S301, the right holder terminal 1 requests the registration of the hash value of the right holder public key Ps in the blockchain data B as the identifier of the right holder. In step S302, the user terminal 2 requests the registration of the hash value of the user public key Pc in the blockchain data B as the identifier of the user. In step S303, the identifiers of the right holder and the user are registered in the blockchain data B and are synchronized in each terminal illustrated in FIG. 1.

In step S304, the user terminal 2 transmits the permission request data for content and the client random number Rc to the right holder terminal 1.

In step S305, the right holder terminal 1 electronically signs the received client random number Rc to generate right holder electronic signature data. In step S306, the right holder terminal 1 transmits the right holder electronic signature data, the server random number Rs, and the right holder public key Ps to the user terminal 2.

In step S307, the user terminal 2 verifies the right holder electronic signature data. Specifically, the user terminal 2 verifies that the right holder electronic signature data is electronically signed by using the right holder secret key Ss corresponding to the right holder public key Ps. Further, the user terminal 2 verifies that the hash value of the right holder public key Ps in the blockchain data B corresponds to the right holder public key Ps obtained in step S306. In step S308, the user terminal 2 electronically signs the received server random number Rs to generate user electronic signature data. In step S309, the user terminal 2 transmits the user electronic signature data to the right holder terminal 1.

In step S310, the right holder terminal 1 verifies the user electronic signature data. Specifically, the right holder terminal 1 verifies that the user electronic signature data is electronically signed by using the user secret key Sc corresponding to the user public key Pc. Further, the right holder terminal 1 verifies that the hash value of the user public key Pc in the blockchain data B corresponds to the user public key Pc obtained in step S309.

In step S310, if it can be confirmed that the user electronic signature data is generated by the user, in step S311, the right holder terminal 1 transmits the permission data to the user terminal 2. In step S312, the user terminal 2 starts using the content. In this case, histories of the distribution of the content by the right holder, histories of the use of the content by the user or histories of the viewing/listening of the content by the user may be registered in the blockchain data B.

In the third application example, the hash value of the right holder public key Ps and the hash value of the user public key Pc are registered in the blockchain data B, and thus, the identifiers of the right holder and the user can be expressed as data having a constant length regardless of a length of the public key itself. This can enable the reduction in the data capacity of the blockchain data B. Further, the right holder and the user exchange each other's public keys with each other without the intervention of the blockchain data B, and therefore, the user and the right holder can verify validities each other.

In the content use system according to the embodiments of the present invention, the identifier of the right holder and the identifier of the user are transmitted and received, and verified via the blockchain data B, and thus, the validities of the right holder and the user can be verified.

### Modified Example

In a modified example, a case will be described in which a common key K is shared between the right holder terminal 1 and the user terminal 2 by using Elliptic curve Diffie-Hellman key exchange, content is encrypted by using the common key K, and the content is delivered.

According to the ECDH key exchange, a key pair of a right holder terminal 1a and a key pair of the user terminal 2a are generated at the right holder terminal 1a and the user terminal 2a respectively, and the right holder terminal 1a and the user terminal 2a exchange one key of the key pair each other so that the exchanged one key is shared between the right holder terminal 1a and the user terminal 2a as a common key. The encryption and decryption of content by using the common key enables the transmission and reception of concealed content between the right holder terminal 1a and the user terminal 2a. Further, in the embodiments of the present invention, descriptions are given for a case where the common key is used for the encryption of the content, but alternatively, the common key may be used for the encryption of a session.

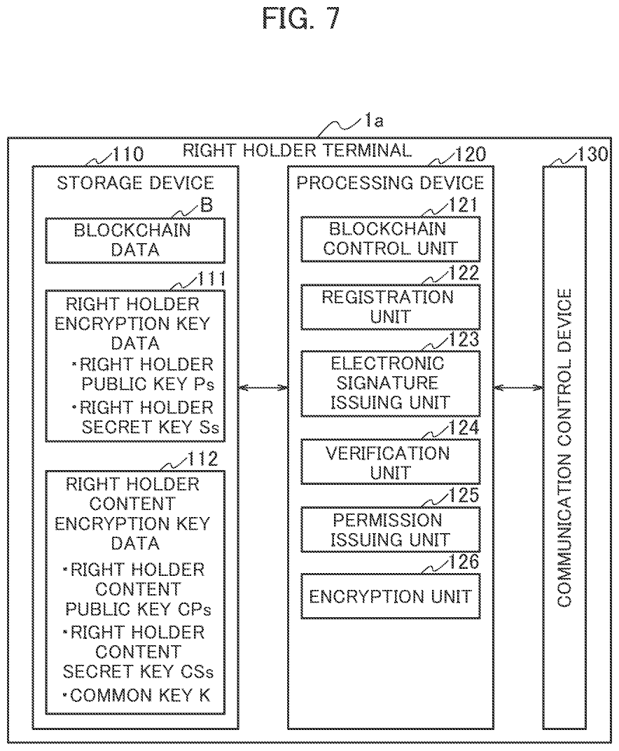

The right holder terminal 1a according to a modified example is described with reference to FIG. 7. The right holder terminal 1a illustrated in FIG. 7 is similar to the right holder terminal 1 according to the embodiments illustrated in FIG. 2 except that the storage device 110 stores right holder content encryption key data 112 and the processing device 120 includes an encryption unit 126.

The right holder content encryption key data 112 is an encryption key of the right holder for encrypting the content. The right holder content encryption key data 112 includes data on a right holder content public key CPs and data on a right holder content secret key CSs as a pair and data on the common key K. The data on the common key K is generated from a user content public key CPc and a right holder content secret key CSs. The right holder content encryption key data 112 may be changed each time a session occurs.

The encryption unit 126 in the right holder terminal 1a generates the right holder content public key CPs and the right holder content secret key CSs as a pair and transmits the right holder content public key CPs to the user terminal 2a. The encryption unit 126 obtains, from the user terminal 2a, a user content public key CPc generated at the user terminal 2a, and generates the common key K by using the user content public key CPc and the right holder content secret key CSs. The encryption unit 126 encrypts the content by using the common key K.

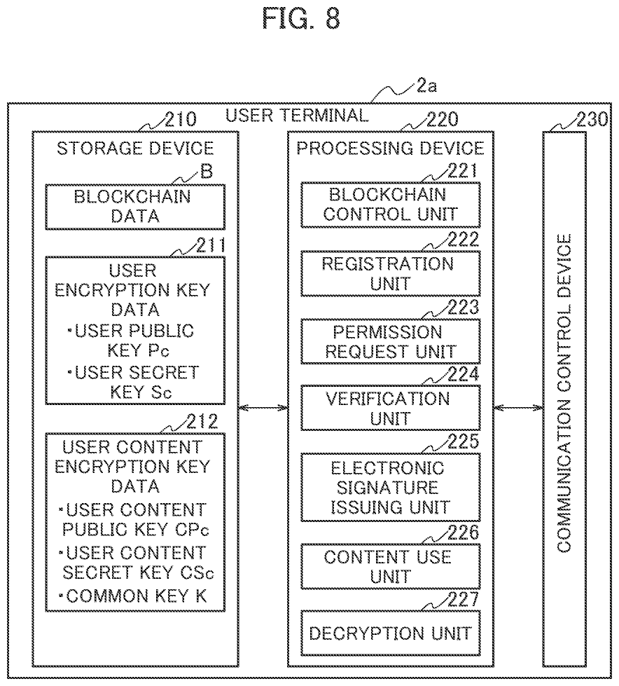

The user terminal 2a according to the modified example will be described with reference to FIG. 8. The user terminal 2a illustrated in FIG. 8 is similar to the user terminal 2 according to the embodiments illustrated in FIG. 3 except that the storage device 210 stores user content encryption key data 212, and the processing device 220 includes a decryption unit 227.

The user content encryption key data 212 is an encryption key of the user for encrypting the content. The user content encryption key data 212 includes data on a user content public key CPc and data on a user content secret key CSc as a pair, and the data on the common key K. The data on the common key K is generated from the right holder content public key CPs and the user content secret key CSc. The user content encryption key data 212 may be changed each time a session occurs.

The decryption unit 227 in the user terminal 2a generates a user content public key CPc and a user content secret key CSc as a pair, and transmits the user content public key CPc to the right holder terminal 1a. The decryption unit 227 obtains, from the right holder terminal 1a, the right holder content public key CPs generated at the right holder terminal 1a, and generates the common key K by using the right holder content public key CPs and the user content secret key CSc. The decryption unit 227 decrypts the content by using the common key K.

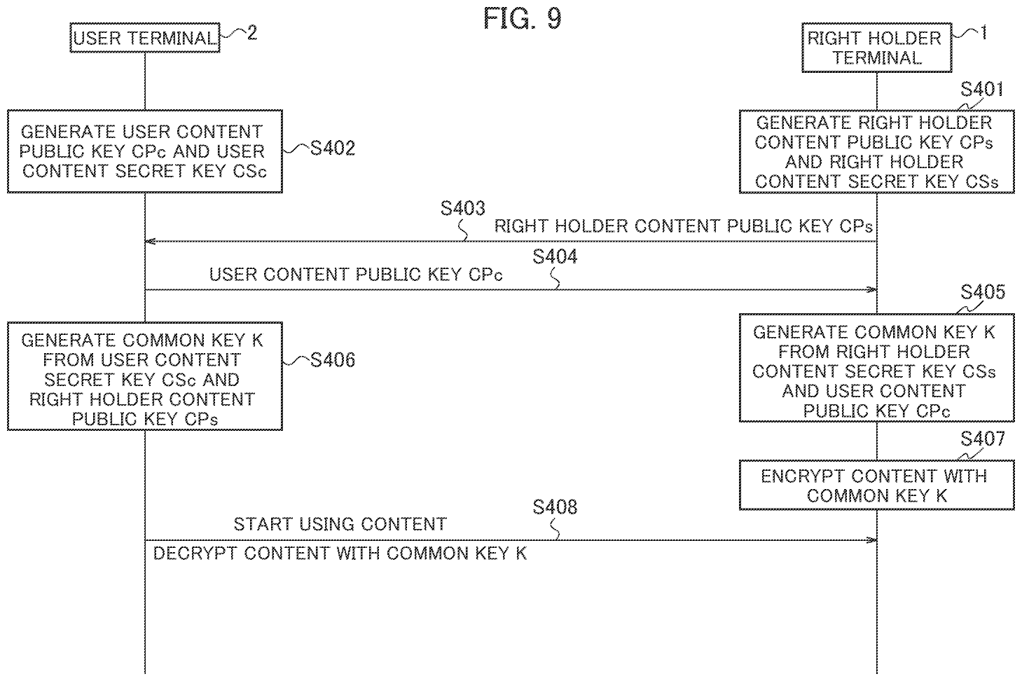

Processes of the ECDH key exchange will be described with reference to FIG. 9.

In step S401, the right holder terminal 1 generates the right holder content public key CPs and the right holder content secret key CSs. In step S403, the right holder terminal 1 transmits the right holder content public key CPs to the user terminal 2.

In step S402, the user terminal 2 generates the user content public key CPc and the user content secret key CSc. In step S404, the user terminal 2 transmits the user content public key CPc to the right holder terminal 1.

In step S405, the right holder terminal 1 generates the common key K from the right holder content secret key CSs and the user content public key CPc. Further, in step S406, the user terminal 2 generates the common key K from the user content secret key CSc and the right holder content public key CPs. In steps S405 and S406, the same common key K is generated.

In step S407, the right holder terminal 1 encrypts content to be transmitted to the user terminal 2 by using the common key K. In step S408, the user terminal 2 decrypts the content by using the common key K and then uses the content.

The processes of steps S401 to S405 illustrated in FIG. 9 are performed until the content is encrypted. If the common key K is also used for encrypting a session, it is preferable that the processes are performed at an early stage of the session between the right holder terminal 1 and the user terminal 2 to avoid the transmission and reception of an unencrypted session.

The processes of steps S403 and S404 of FIG. 9 are performed at steps S106 and S104 of FIG. 4 in the first application example. The processes of steps S403 and S404 of FIG. 9 are performed at steps S206 and S204 of FIG. 5 in the second application example. The processes of steps S403 and S404 of FIG. 9 are performed at steps S306 and S304 of FIG. 6 in the third application example.

Accordingly, the session can be encrypted by using the common key K, and thus, the concealment of communication is ensured.

### Other Embodiments

Although, as described above, the embodiments and modified examples of the present invention have been described, the descriptions and drawings which form a part of this disclosure should not be construed as limiting the present invention. Various alternative embodiments, examples, and operational techniques will be apparent to a person skilled in the art from this disclosure.

For example, the right holder terminal described in the embodiments of the present invention may be constituted on one piece of hardware as illustrated in FIG. 2 or alternatively may be constituted on a plurality of pieces of hardware depending on the functions and the number of processes of the right holder terminal.

The orders of the processes described with reference to sequence diagrams are merely an example, and orders are not limited to the order of the present invention.

It is needless to say that the present invention includes various embodiments and the like which are not described herein. Therefore, the technical scope of the present invention is determined only by the matters specifying the invention according to the claims which are reasonable from the above description.

### EXPLANATION OF THE REFERENCE NUMERALS

1 Right holder terminal
2 User terminal
3 Blockchain control terminal
4 Communication network
5 Content use system
110, 210 Storage device
111 Right holder encryption key data
112 Right holder content encryption key data
120, 220 Processing device
121, 221 Blockchain control unit
122, 222 Registration unit
123, 225 Electronic signature issuing unit
124, 224 Verification unit
125 Permission issuing unit
126 Encryption unit
130, 230 Communication control device
211 User encryption key data
212 User content encryption key data
223 Permission request unit
226 Content use unit
227 Decryption unit
B Blockchain data
CPc User content public key
CPs Right holder content public key
CSc User content secret key
CSs Right holder content secret key
K Common key
Pc User public key
Ps Right holder public key
Rc Client random number
Rs server random number
Sc User secret key
Ss Right holder secret key

1. A right holder terminal that is used by a right holder of content and transmits permission data for the content to a user of the content, the right holder terminal comprising:
a storage device configured to store a right holder public key and a right holder secret key of the right holder;
a registration unit configured to register an identifier of the right holder in a distributed ledger registered with an identifier of the user;
an electronic signature issuing unit configured to receive, from a user terminal used by the user, permission request data for the content and a client random number issued by the user terminal, and transmit, to the user terminal, right holder electronic signature data generated by electronically signing the client random number by using the right holder secret key;
a verification unit configured to transmits transmit, to the user terminal, a server random number issued by the right holder terminal, receive, from the user terminal, user electronic signature data generated by electronically signing the server random number by using a user secret key, and verify that the user electronic signature data corresponds to the identifier of the user registered in the distributed ledger; and
a permission issuing unit configured to, if the user electronic signature data corresponds to the identifier of the user registered in the distributed ledger, transmit the permission data to the user terminal.

2. The right holder terminal according to claim 1, wherein
the distributed ledger is registered with a hash value of the right holder public key as the identifier of the right holder and is registered with a hash value of a user public key corresponding to the user secret key as the identifier of the user,
the right holder electronic signature data is data generated by the right holder terminal electronically signing the client random number based on an electronic signature method in which the right holder public key can be restored by using the right holder secret key,
the user electronic signature data is data generated by the user terminal electronically signing the server random number based on an electronic signature method in which the user public key can be restored by using the user secret key, and
the verification unit is configured to store the user public key from the user electronic signature data and verify that the restored user public key corresponds to the hash value of the user public key registered in the distributed ledger.

3. The right holder terminal according to claim 1, wherein the distributed ledger is registered with the right holder public key as the identifier of the right holder and is registered with a user public key as the identifier of the user; and
the verification unit is configured to obtain the user public key from the distributed ledger and verify the user electronic signature data relative to the server random number by using the user public key.

4. The right holder terminal according to claim 1, wherein the distributed ledger is registered with a hash value of the right holder public key as the identifier of the right holder and is registered with a hash value of a user public key as the identifier of the user,
the right holder public key is transmitted to the user terminal, and
the verification unit is further configured to obtain the user public key from the user terminal and verify that the obtained user public key corresponds to the hash value of the user public key registered in the distributed ledger.

5. The right holder terminal according to claim 1, further comprising:
an encryption unit configured to generate a right holder content public key and a right holder content secret key as a pair, transmit the right holder content public key to the user terminal, obtain, from the user terminal, a user content public key generated at the user terminal, generate a common key by using the user content public key and the right holder content secret key, and encrypt the content by using the common key.

6. A user terminal that is used by a user of content and transmits permission request data for the content to a right holder of the content, the user terminal comprising:
a storage device configured to store a user public key and a user secret key of the user;
a registration unit configured to register an identifier of the user in a distributed ledger registered with an identifier of the right holder;
a permission request unit configured to transmit the permission request data for the content to a right holder terminal used by the right holder;
a verification unit configured to transmit a client random number issued by the user terminal to the right holder terminal, receive, from the right holder terminal, right holder electronic signature data generated by electronically signing the client random number by using a right holder secret key, and verify that the right holder electronic signature data corresponds to the identifier of the right holder registered in the distributed ledger;
an electronic signature issuing unit configured to receive, from the right holder terminal, a server random number issued by the right holder terminal and transmit, to the right holder terminal, user electronic signature data generated by electronically signing the server random number by using the user secret key; and
a content use unit configured to start using the content after receiving permission data from the right holder terminal.

7. The user terminal according to claim 6, wherein
the distributed ledger is registered with a hash value of a right holder public key corresponding to the right holder secret key as the identifier of the right holder and is registered with a hash value of the user public key as the identifier of the user,
the right holder electronic signature data is data generated by the right holder terminal electronically signing the client random number based on an electronic signature method in which the right holder public key can be restored by using the right holder secret key,
the user electronic signature data is data generated by the user terminal electronically signing the server random number based on an electronic signature method in which the user public key can be restored by using the user secret key, and
the verification unit is configured to restore the right holder public key from the right holder electronic signature data and verify that the restored right holder public key corresponds to the hash value of the user public key registered in the distributed ledger.

8. The user terminal according to claim 6, wherein
the distributed ledger is registered with a right holder public key as the identifier of the right holder and is registered with the user public key as the identifier of the user, and
the verification unit is configured to obtain the right holder public key from the distributed ledger and verify the right holder electronic signature data relative to the client random number by using the right holder public key.

9. The user terminal according to claim 6, wherein
the distributed ledger is registered with a hash value of a right holder public key as the identifier of the right holder and is registered with a hash value of the user public key as the identifier of the user,
the user public key is transmitted to the right holder terminal, and
the verification unit is further configured to obtain the right holder public key from the right holder terminal and verify that the obtained right holder public key corresponds to the hash value of the right holder public key registered in the distributed ledger.

10. The user terminal according to claim 6, further comprising:
a decryption unit configured to generate a user content public key and a user content secret key as a pair, transmit the user content public key to the right holder terminal, obtain, from the right holder terminal, a right holder content public key generated at the right holder terminal, generate a common key by using the right holder content public key and the user content secret key, and decrypt the content by using the common key.

11.-13. (canceled)

14. A content use method for a content use system comprising, a right holder terminal that is used by a right holder of content and transmits permission data for the content to a user of the content, and a user terminal that is used by the user of the content and transmits permission request data for the content to the right holder of the content, the content use method comprising the steps of:
storing, by the right holder terminal, a right holder public key and a right holder secret key of the right holder in a storage device;
storing, by the user terminal, a user public key and a user secret key of the user in a storage device;
registering, by the right holder terminal, an identifier of the right holder in a distributed ledger registered with an identifier of the user;
registering, by the user terminal, the identifier of the user in a distributed ledger registered with the identifier of the right holder;
transmitting, by the user terminal, the permission request data for the content to the right holder terminal used by the right holder;
transmitting, by the user terminal, a client random number issued by the user terminal to the right holder terminal;
receiving, by the right holder terminal, from the user terminal used by the user, the permission request data for the content and the client random numbers issued by the user terminal, and transmitting, to the user terminal, right holder electronic signature data generated by electronically signing the client random number by using the right holder secret key;
receiving, by the user terminal, from the right holder terminal, the right holder electronic signature data generated by electronically signing the client random number by using the right holder secret key, and verifying that the right holder electronic signature data corresponds to the identifier of the right holder registered in the distributed ledger;
transmitting, by the right holder terminal, a server random number issued by the right holder terminal to the user terminal;
receiving, by the user terminal, from the right holder terminal, the server random number issued by the right holder terminal and, transmitting, to the right holder terminal, user electronic signature data generated by electronically signing the server random number by using the user secret key;
receiving, by the right holder terminal, from the user terminal, the user electronic signature data generated by electronically signing the server random number by using the user secret key, and verifying that the user electronic signature data corresponds to the identifier of the user registered in the distributed ledger;
transmitting, by the right holder terminal, the permission data to the user terminal if the user electronic signature data corresponds to the identifier of the user registered in the distributed ledger; and
using the content, by the user terminal, after the user terminal receiving the permission data from the right holder terminal.

15. The content use method according to claim 14, further comprising:
registering the distributed ledger with a hash value of the right holder public key as the identifier of the right holder;
registering the distributed ledger with a hash value of a user public key corresponding to the user secret key as the identifier of the user;
storing, by a verification unit of the right holder terminal, the user public key from the user electronic signature data; and
verifying, by the verification unit of the right holder terminal, that the restored user public key corresponds to the hash value of the user public key registered in the distributed ledger.

16. The content use method according to claim 14, further comprising:
registering the distributed ledger with the right holder public key as the identifier of the right holder;
registering the distributed ledger with a user public key as the identifier of the user;
obtaining, by the verification unit, the user public key from the distributed ledger; and
verifying, by the verification unit, the user electronic signature data relative to the server random number by using the user public key.

17. The content use method according to claim 14, further comprising:
registering the distributed ledger with a hash value of the right holder public key as the identifier of the right holder;
registering the distributed ledger with a hash value of a user public key as the identifier of the user;
transmitting the right holder public key to the user terminal;
obtaining, by the verification unit, the user public key from the user terminal; and
verifying, by the verification unit, that the obtained user public key corresponds to the hash value of the user public key registered in the distributed ledger.

18. The content use method according to claim 14, further comprising:
generating, by an encryption unit of the right holder terminal, a right holder content public key and a right holder content secret key as a pair;
transmitting, by an encryption unit of the right holder terminal, the right holder content public key to the user terminal;
obtaining, by an encryption unit of the right holder terminal from the user terminal, a user content public key generated at the user terminal;
generating, by an encryption unit of the right holder terminal, a common key by using the user content public key and the right holder content secret key; and
encrypting, by an encryption unit of the right holder terminal, the content by using the common key.
